(19) United States
(12) Patent Application Publication
(10) Pub. No.: US 2006/0154599 A1
(43) Pub. Date: Jul. 13, 2006

(54) Systems, methods, and media for providing wireless electronic messaging

(76) Inventors: Faheem Altaf, Pflugerville, TX (US); Kumar Ravi, Cedar Park, TX (US); Eric Siegfried Rybczynski, Round Rock, TX (US); Manuel Silveyra, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/032,262

(22) Filed: Jan. 10, 2005

(51) Int. Cl. H04H 7/00

(52) U.S. Cl. 455/3.06

(57) ABSTRACT

Systems, methods and media for providing a wireless message to a recipient on a wireless device are provided. More particularly, hardware and/or software for providing a wireless message to a recipient on a wireless device when at least a portion of a broadcast message matches at least a portion of profile information associated with the recipient are disclosed. Embodiments may include receiving a broadcast message having recipient information and comparing the recipient information to profile information to determine if there is a match. In response to a match of at least a portion of the recipient information to at least a portion of the profile information, embodiments may also include communicating at least a portion of the broadcast message to a recipient. Further embodiments may also include determining if the profile information satisfies conditions of the broadcast message when the broadcast message includes a condition for broadcast message recipients.

### FIELD OF INVENTION

The present invention is in the field of computer systems. More particularly, the present invention relates to systems, methods and media for providing wireless messaging, particularly for electronically messaging a wireless device.

### BACKGROUND

Individuals spend a considerable amount of time in large, public places such as airports, buildings, stores or malls, as well as events such as concerts, conferences, shows, and the like. In these places or at these events, individuals often want to find others in the same area. A parent, for example, may want to find their child whom they have lost in the mall. In another example, a businessperson might want to send a message to a colleague at a conference that both are attending. In another example, a customer service representative for an airline might want to find an airline passenger at an airport to inform them that an upgrade is available. Each of these situations presents different difficulties, but for many situations current solutions to the problem of contacting others are inadequate.

One common solution to this problem is to use a public address (PA) system that uses speakers to broadcast a message that all ostensibly can hear. Unfortunately, even though a PA system does sometimes work as intended, individuals often do not hear broadcasted PA messages directed to them. In some cases, the individual might be in a restroom or temporarily outside the facility and therefore miss the PA message. In other cases, the background noise in the facility may drown out the PA message so that it is missed by its intended recipient. An individual may be in the facility but also be distracted, such as on a cell phone call, and miss hearing a PA message intended for them. Even when PA messages reach their intended recipient, they are often very short (as it is more intrusive to have longer messages) and provide little information because of the nature of the PA system. Moreover, many people in areas where PA systems are common, such as airports, end up “tuning out” broadcast messages that they would otherwise hear because of the frequency of the PA messages.

Another common solution to this problem is to use a wireless device such as a cell phone, personal digital assistant (PDA), or electronic pager to try to contact or find individuals. One problem, however, with this solution is that one must know the phone number of the wireless device (or e-mail address, instant messaging ID, etcetera, depending on the type of device) in order to contact someone on that wireless device, information that is often unavailable. For example, if a lost child is found at the mall and the mall security personnel desire to contact the parents, the mall security personnel will not have any information about the parents' wireless devices and instead must rely on a traditional PA system, which is unsatisfactory for the reasons previously described. In another example, if a conference organizer wishes to contact an individual at their conference during a break, neither using a PA system nor contacting their wireless device will likely prove satisfactory, as many people leave the facility during a break (to go outside, to check their messages) and are thus unlikely to hear a broadcast PA message and the conference organizer is unlikely to have the individual's cell phone number or other contact information.

Just as the PA system often proves unsuccessful in airports for contacting individuals about ticket, reservation or security matters, contacting the individual on their wireless device is often just as unsuccessful. In most cases, the airline or airport personnel do not have the individual's cell phone number (or other number) because they usually only require a home or other contact number to purchase a ticket.

There is, therefore, a need for an efficient and effective mechanism for providing messages to individuals, particularly for those individuals who are in locations where traditional PA systems are not very successful. There is an even greater need for such a mechanism when the telephone number or other contact information for an individual with a wireless device is not known.

### SUMMARY

The problems identified above are in large part addressed by systems, methods and media for providing wireless electronic messaging. One embodiment provides a method for providing electronic messaging to a wireless device on a wireless network. The method generally includes receiving by the wireless device a broadcast message having recipient information from a wireless messaging computer and then comparing by the wireless device the recipient information to profile information. The method also generally includes communicating by the wireless device to a recipient at least a portion of the broadcast message in response to a match of at least a portion of the recipient information to at least a portion of the profile information. Further embodiments also generally include receiving input on the wireless device in response to the displayed broadcast message and transmitting by the wireless device an indication of the input to the wireless messaging computer.

A further embodiment provides a method for providing wireless electronic messaging to at least one wireless device on a wireless network having a plurality of wireless devices capable of communicating on the network. The method generally includes receiving by a wireless messaging computer a request to contact one or more of the wireless devices where the request includes both recipient information associated with the one or more wireless devices and message content. The method also generally includes generating by the wireless messaging computer a broadcast message incorporating at least a portion of the recipient information and the message content and broadcasting by the wireless messaging computer the broadcast message over the wireless network such that a plurality of the wireless devices in the wireless network receive the message but only the wireless devices identified in the request display the message content to a recipient.

A further embodiment provides a wireless device that may generally include a listener module for receiving a broadcast message, a profile cache for storing a recipient profile, and a profile comparison module for determining if there is a match between the recipient profile and the received broadcast message. If there is a match of at least a portion of the recipient profile and at least a portion of the broadcast message, a user communication module of the wireless device may communicate the broadcast message to a recipient. The user communication module may comprise one or more of a display, a speaker, or a printer.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for providing wireless electronic messaging to a recipient on a wireless device according to one embodiment;

FIG. 2 depicts a wireless device of the wireless messaging system of FIG. 1 according to one embodiment;

FIG. 3 depicts an example of a flow chart for generating and broadcasting a broadcast message according to one embodiment;

FIG. 4 depicts an example of a flow chart for receiving a broadcast message according to one embodiment; and

FIG. 5 depicts an example of a flow chart for receiving a broadcast message according to an alternative embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for providing a wireless message to a recipient on a wireless device are provided. More particularly, hardware and/or software for providing a wireless message to a recipient on a wireless device when at least a portion of a broadcast message matches at least a portion of profile information associated with the recipient are disclosed. Embodiments may include receiving a broadcast message having recipient information and comparing the recipient information to profile information to determine if there is a match. In response to a match of at least a portion of the recipient information to at least a portion of the profile information, embodiments may also include communicating at least a portion of the broadcast message to a recipient. Further embodiments may also include determining if the profile information satisfies conditions of the broadcast message when the broadcast message includes a condition for recipients of the broadcast message.

The disclosed embodiments provide an effective and efficient methodology for providing messages to recipients using wireless devices. By utilizing recipient information in a broadcast message and profile information, broadcast messages may be easily tailored to individual recipients or groups of recipients. The disclosed embodiments provide a methodology for a recipient to receive broadcast messages directed towards them quickly and effectively without being bothered with extraneous messages. The disclosed embodiments also provide a mechanism for generating and broadcasting broadcast messages to individual recipients or groups of recipients. By matching a recipient profile with the broadcast message, the broadcast messages may be carefully tailored to reach only certain recipients. The methodology of the disclosed embodiments is more effective than a traditional PA system in many cases, as it is more certain to reach the intended recipients (and less likely to bother unintended recipients). The disclosed methodology also provides an advantage in some cases to directly contacting recipients on their wireless device, as the phone number or other contact number of the recipient need not be known.

While specific embodiments will be described below with reference to particular configurations of hardware and/or software, those of skill in the art will realize that embodiments of the present invention may advantageously be implemented with other substantially equivalent hardware and/or software systems.

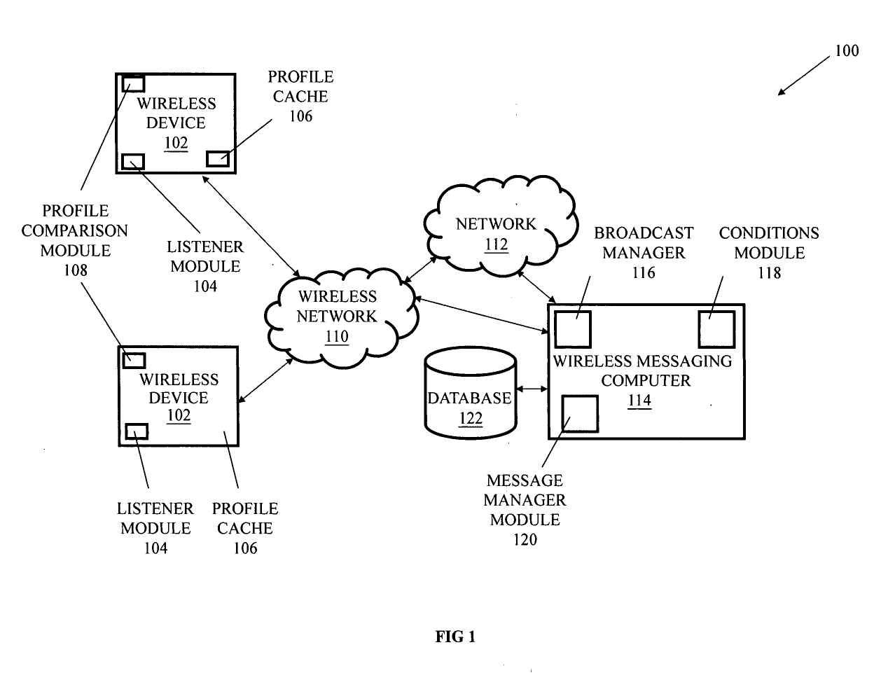

Turning now to the drawings, FIG. 1 depicts an environment for a system for providing wireless electronic messaging to a recipient on a wireless device according to one embodiment. In the depicted embodiment, the wireless messaging system 100 includes one or more wireless devices 102 (each of which may have an associated recipient, or user, using the wireless device 102) in communication with a wireless network 110. Each wireless device 102 may include a listener module 104 for receiving wireless broadcast messages and a profile cache 106 for storing profile information associated with the recipient. Each wireless device 102 may also include a profile comparison module 108 for comparing profile information from the profile cache 106 to recipient information within a wireless broadcast message. Wireless network 110 may be in communication with a wireless messaging computer 114 either directly or via another network such as network 112. The wireless messaging computer 114 provides, in the depicted embodiment, a mechanism for generating and broadcasting broadcast messages (also known as broadcast pages) containing recipient information to one or more wireless devices 102, where the profile comparison module 108 of each wireless device 102 may compare recipient information of the broadcast message to the profile information to determine if any of the profile information matches any of the recipient information. An optional database 122 may also be in communication with the wireless messaging computer 114 to provide storage of recipient information, preferences, settings, etcetera.

Wireless device 102 may include any device adapted to allow a recipient to communicate with a wireless network 110, including portable and mobile devices. Example wireless devices 102 include mobile phones, cellular phones, wireless-enabled personal digital assistants (PDAs), notebook computers, tablet personal computers, portable computer systems, wireless-enabled pagers, automotive-based wireless devices, wearable wireless devices, Bluetooth-enabled devices or any wireless-enabled device.

The listener module 104 of the wireless device 102 may be adapted to receive a wireless broadcast message via the wireless network 110. In one embodiment, the listener module 104 may be active whenever the wireless device 102 is active so that all wireless broadcast messages may be received when the wireless device 102 is on and within range of the wireless network 110. The listener module 104 may be same receiver utilized to receive other wireless signals for the wireless device 102. In this embodiment, the receiver simultaneously listens for incoming rings or transmissions from its carrier while also listening for broadcast messages. In another embodiment, the listener module 104 may be separate from other wireless communication components of the wireless device 102. In another embodiment, the listener module 104 may also transmit a response to a broadcast message to a wireless messaging server 114 via wireless network 110.

The profile cache 106 of the wireless device 102 may be adapted to store recipient profile information for use by the profile comparison module 108. Recipient profile information may be any information used by the profile comparison module 108 to compare to contents of a broadcast message received by the listener module 104. Recipient profile information may include information identifying a recipient, such as a name, social security number, identification name or number, frequent flyer number, frequent customer number, etcetera. Recipient profile information may also include information associated with a recipient, such as the identity of a recipient's organization (employer, school, club, office, etcetera) or a characteristic of a recipient (registered on a particular flight, seeking information on the score from a particular game, hometown, zip code, etcetera). In an alternative embodiment, recipient profile information may include information relating to others for which the recipient has an interest, such as friends or family. For example, a parent may include the child's and spouse's name as part of their recipient profile. Any type of information may be used as part of a recipient's profile information.

Recipient profile information may be placed in the profile cache 106 in any fashion. In one example, a recipient may select profile information to be placed in the profile cache 106. A recipient in this example may select their name, their spouse's name, and the company name as part of their recipient profile. In another embodiment, information may be automatically included in the recipient profile based on various criteria. For example, the name of a recipient's employer, people in their contact list, people on their calendar, etcetera may be found somewhere on the wireless device 102 and included as part of the recipient profile in the profile cache 106.

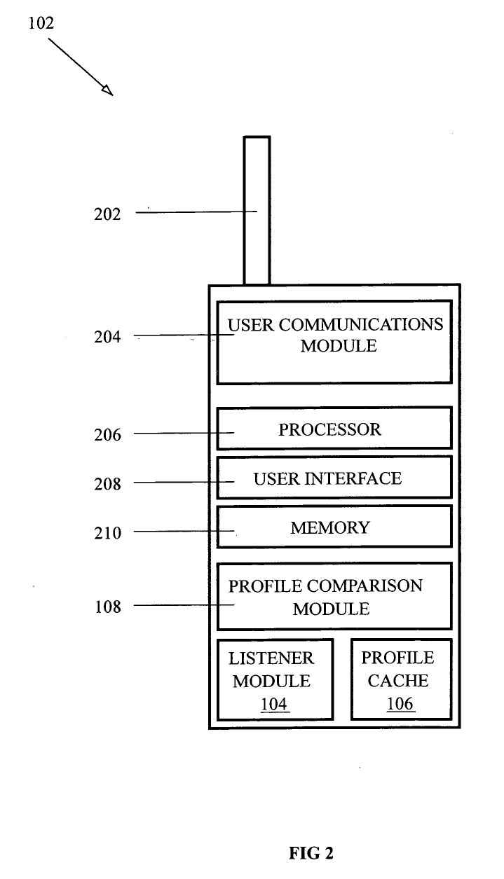

The profile comparison module 108 may be used to compare the recipient profile of the profile cache 106 with the contents of a broadcast message. Information for comparison in the broadcast message may be embedded anywhere in the message, including in a header or designated field. One or multiple portions of the recipient profile may be compared to the broadcast message to determine if any portion of the recipient profile matches any portion of the broadcast message. In one example, if a recipient's name is included in their recipient profile and their name is also included in the broadcast message, the profile comparison module 108 will determine that there is a match and that the recipient is an intended recipient of the message. The message may then be displayed to the recipient, as described in more detail in relation to FIG. 2.

In an alternative embodiment, the profile comparison module 108 may use a more sophisticated methodology than a simple comparison. In one example, the profile comparison module 108 may require that a certain number of matches be made (two out of three must be met, over 50% must be met). In another example, negative matching may also be used. In this example, if a recipient worked for company ‘A’, they may desire to see broadcast messages that include their name and does not include any other company names (‘B’, ‘C’, and so on). This may be particularly useful for someone who is part of a large, multi-office organization who also has a relatively common name. For example, a recipient profile could specify a recipient name of “John Doe” who works for company “A” who wishes to exclude similarly-named people in the office in New York. If a broadcast message included “John Doe” and company “A” but included New York for the office, the profile comparison module 108 would reject the broadcast message in this example. Any appropriate methodology may be used to compare the recipient profile with the broadcast message. Methodologies useful in data mining may be useful for the comparison of the recipient profile information with the recipient information in the broadcast message.

Wireless network 110 may be any type of wireless network, including a cellular network, Bluetooth-based network, etcetera. Network 112 may be any type of data communications channel, such as the Internet, an intranet, a LAN, a WAN, an Ethernet network, wireless network, or telephone network. In one embodiment, the wireless device 102 may be in communication with a base station as part of the wireless network 110, which in turn may be in communication with a mobile switching center, gateway mobile switching center (GMSC), or other elements of a wireless or cellular network 112. In another embodiment, wireless network 110 may communicate with a telephone network 112 (or other wireless or cellular networks) via a GMSC. The wireless network 110, in one embodiment, communicates with the Internet or other network 112 using the Wireless Access Protocol (WAP) via a WAP gateway, which translates between the protocols of the World Wide Web (WWW) and the WAP protocols of some wireless devices 102. Those skilled in the art will recognize, however, that types of data communication channels between the wireless device 102 and the wireless messaging computer 114 may be used without departure from the scope and spirit of the invention.

Wireless messaging computer 114 may provide for the creation and/or broadcasting of broadcast messages intended for recipients on wireless devices 102. The wireless messaging computer 114 of the depicted embodiment includes a broadcast manager 116, a conditions module 118, and a supplementary server interface 120. The wireless messaging computer 114 may be one or more of any type of computer system, including servers, personal computers, workstations, mainframe computers, notebook or laptop computers, desktop computers, or the like. In one embodiment, the wireless messaging computer 114 is an IBM® eServer or similar server having one or more processors, or threads of processors, executing software and/or one or more state machines coupled with data storage devices such as random access memory (RAM), read only memory (ROM), flash memory, compact disk drives, hard drives, and the like. The wireless messaging computer 114 may be in communication with (or include) a database 122 for storage of recipient information, message information, message transmittal histories, preferences, etcetera. The broadcast manager 114 may be used to facilitate communication, particularly relating to broadcast messages to be broadcast to recipients, between the wireless messaging computer 114 and the wireless device 102. As described above, the broadcast manager 114 may utilize the network 112 and/or the wireless network 110 in order to broadcast messages to wireless devices 102.

Similarly to the profile comparison module 108, the conditions module 118 may serve to restrict viewing of the broadcast message by defining conditions for recipients of the broadcast message. A condition defines any requirement for selecting intended recipients of the broadcast message that is imposed by the wireless messaging computer 114 instead of by another entity (such as a third party requesting a broadcast message). For example, one condition may be that recipients work for a particular company. This condition may be added to a broadcast message that has, for example, recipient information that includes the recipient's name. The wireless device 102 (having a recipient profile with a matching recipient name) may then receive the broadcast message with the recipient information and condition. Although the recipient name matches, if the recipient profile does not also include the company name the condition is not satisfied, and the broadcast message will not be communicated to the recipient of that wireless device 102, regardless of the settings of the profile comparison module 108 of the wireless device 102. Conditions may be set by an administrator, by preference of the entity requesting the broadcast message to be sent out, etcetera.

The message manager module 120 may be used to generate broadcast messages for ultimate transmission or broadcast by the broadcast manager 118. The broadcast message may include both content to be displayed to recipients or any other information, such as information relating to send time, origin, etcetera. Information may be placed anywhere in the broadcast message that may be used to match a recipient profile. In one example, the broadcast message may include a profile field that contains elements to be matched with a recipient profile. In another example, elements may be in a header, embedded in text of the message, etcetera. The broadcast message may, in one embodiment, be in Extensible Markup Language (XML) format or another wireless format. Input to the message manager module 120 regarding the content and recipient of a broadcast message may come from any source. In one embodiment, the message manager module 120 receives a request for a broadcast message from another computer system. In another embodiment, an administrator may request a particular broadcast message. In yet another embodiment, a broadcast message may be automatically generated by the message manager module 120 in response to an action or the occurrence of an event, such as a flight being delayed.

The disclosed embodiments of the wireless messaging system 100 provide an efficient and effective method of messaging recipients using wireless devices 102. The disclosed embodiments provide a mechanism for a recipient using a wireless device 102 to receive broadcast messages directed towards them while ignoring messages not directed towards them. The disclosed embodiments also provide a mechanism for generating and broadcasting broadcast messages to individual recipients or groups of recipients. By matching a recipient profile with the broadcast message, broadcast messages may be carefully tailored to reach certain recipients (and only those recipients). The methodology of the disclosed embodiments may be more effective than a PA system, as it is more certain to reach the intended recipients and less likely to bother unintended recipients. The disclosed methodology also provides an advantage when compared to directly contacting recipients on their wireless device 102, as the phone number or other contact number of the recipient need not be known.

FIG. 2 depicts a wireless device 102 of the wireless messaging system 100 of FIG. 1 according to one embodiment. In the depicted embodiment, the wireless device 102 includes a listener module 104, a profile cache 106, a profile comparison module 108, an antenna 202, a user communication module 204, a processor 206, a recipient interface 208, and one or more memory modules 210. The listener module 104, profile cache 106, and profile comparison module 108 have been described in relation to FIG. 1.

Antenna 202 may be an external or internal antenna adapted to facilitate communication between the wireless device 102 and the wireless network 110. User communications module 204 may be, for example, a display screen for displaying information, such as the contents of a broadcast message, to the recipient. Any apparatus for conveying information to the recipient, such as a printer or speaker, is also contemplated. Processor 206 may be used to perform necessary tasks for the wireless device 102, such as calculations, handling the various subsystems, etcetera. In some embodiments, one processor 206 may be used for execution of instructions; in other embodiments, one or more processors or threads of processors 206 may be used to execute instructions.

User interface 208 may be any apparatus which accepts input from a recipient, such as buttons, dials, keys, keypad, levers, a voice recognition device, a device for accepting optical input, etcetera. In some embodiments, user interface 208 utilizes existing input devices, such as buttons or a touch-screen, so as to not require additional complexity. The one or more memory modules 210 may be used to storage any information, such as recipient preferences, older broadcast messages, etcetera. In one embodiment, the one or more memory modules 210 may serve as the profile cache 106. The memory module(s) may include random access memory (RAM), such as double data rate (DDR) synchronous dynamic RAM (SDRAM), caches, buffers, read only memory (ROM), flash memory, and/or remote data storage like magnetic disk storage media, optical storage media, and flash memory drives.

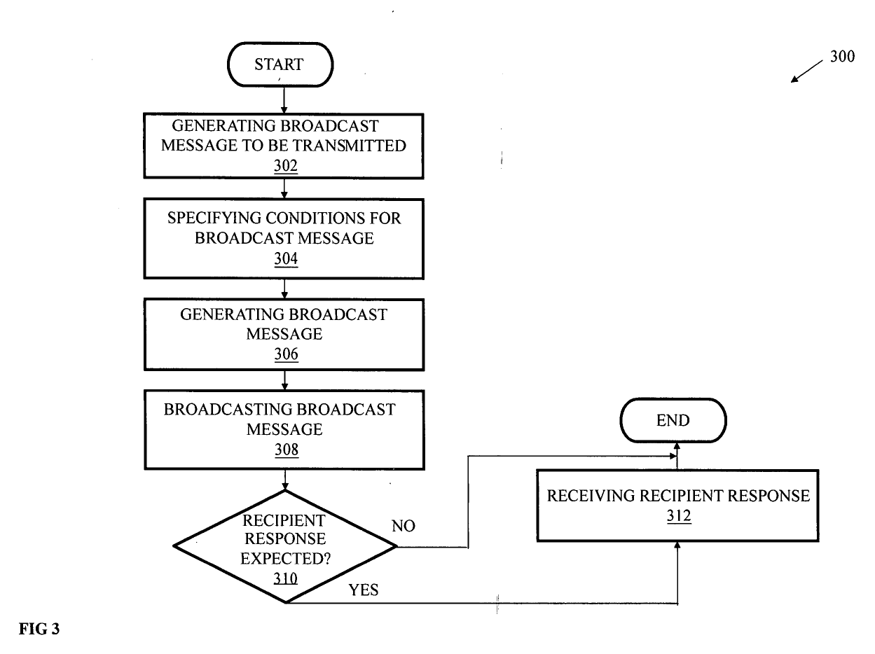

FIG. 3 depicts an example of a flow chart for generating and broadcasting a broadcast message according to one embodiment. The method of flow chart 300 may be performed, in one embodiment, by the wireless messaging computer 114. Flow chart 300 begins with element 302, generating the broadcast message to be transmitted. This element may, in one embodiment, be performed by the message manager module 120 of the wireless messaging computer 114. In one embodiment of element 302, content for a broadcast message may be received at the wireless messaging computer 114 from another source, such as another computer system, after which the broadcast message itself is then generated. In another embodiment of element 302, the content for the broadcast message may be generated at the wireless messaging computer 114, such as in response to input at the wireless messaging computer 114 or to a particular action or event. Information to be matched with a recipient profile may also be added to the broadcast message. Information may include recipient names, identifying numbers (such as frequent flyer numbers), identifying characteristics (company, organization), etcetera. The elements may be added in the text of the broadcast message or in a specified field, header, etcetera.

The method of flow chart 300 continues to optional element 304, specifying conditions for the broadcast message. In one embodiment, the conditions module 118 may be used to perform element 304. A condition may be any requirement imposed on selecting intended recipients of the broadcast message. Example conditions may include only providing the message to recipients from a particular company, associated with a particular location, having a certain account status (account is active and paid up), etcetera. By setting conditions on the broadcast message, the profile comparison module 108 of the wireless device 102 may be overridden and messages prohibited from display or other communication to recipients. For example, a profile comparison module 108 may specify that all messages with a certain recipient name be displayed to a recipient. The condition, on the other hand, may specify that only recipients associated with a specific company receive the broadcast message. In this example, even if the name in the recipient profile matched the name in the broadcast message, the recipient would not see the broadcast message unless they also were associated with that particular company (and that fact was reflected in the profile cache 106). This provides more control of the wireless messaging system 100 for administrators or others sending out broadcast messages. Some embodiments of the conditions module 118 may require modifications to the profile comparison module 108 so as to accommodate the various conditions.

Another alternative embodiment for element 304 provides for another override (by forcing messages) of the profile comparison module 108 by the conditions module 118. In this embodiment, a broadcast message for a recipient or group of recipients may be specified in the conditions module 118 that displays a message to a recipient despite the contents of the profile cache 106. For example, a message may be sent to all recipients regardless of profile cache 106 by appropriate configuration of the conditions module 118. This example may be particularly suited for an emergency broadcast system, such as notifying recipients in an airport terminal of a security violation, notifying recipients in a building of a safety risk, etcetera. In this example, control of the power to override may be carefully controlled (to law enforcement authorities) so that others, such as spammers, cannot take advantage of it.

The method of flow chart 300 continues to element 306, generating the broadcast message. In this element, the message manager module 120 may create a broadcast message based on the message generated or received in element 302 and any conditions specified in optional element 304. Any recipient profile elements to be matched or conditions may be incorporated into the broadcast message in any fashion. Method 300 next continues to element 308, broadcasting the broadcast message. In this element, the broadcast message generated in element 306 may be broadcasted by network 112 and/or wireless network 110 for ultimate receipt by a wireless device 102.

Method 300 next continues to decision block 310, where it is determined if a response from the recipient is expected. If no response is expected, the method simply terminates (and decision block 310 may be removed in its entirety). If a recipient response is expected, the method continues to element 312, receiving a recipient response, after which the method terminates. A recipient response may be an acknowledgement of receipt of the broadcast message, a reply message, a response to a query in the broadcast message, etcetera. In an alternative embodiment, element 308 may be repeated if a recipient response has not been received after a certain period of time, etcetera.

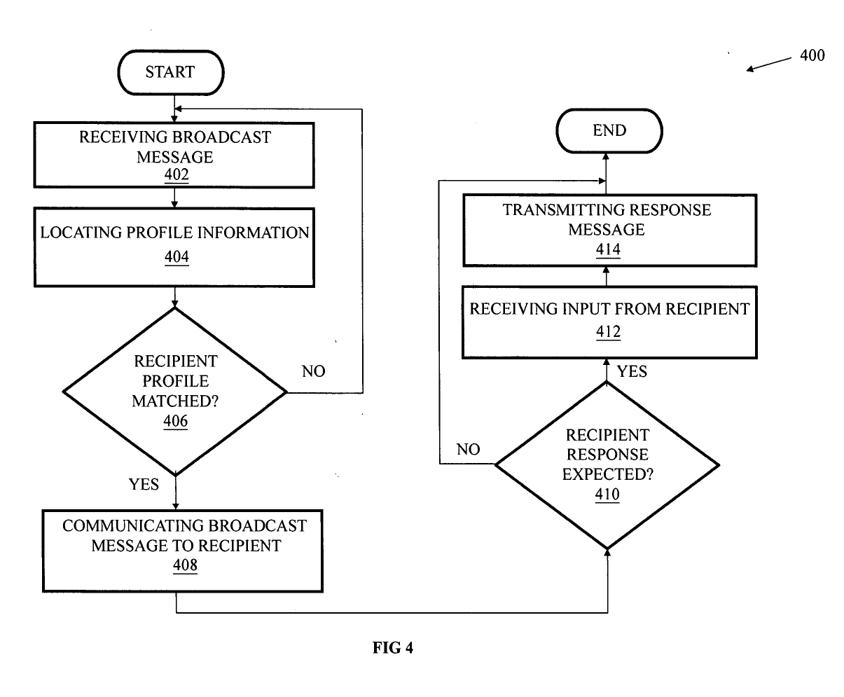

FIG. 4 depicts an example of a flow chart for receiving a broadcast message according to one embodiment. The method of flow chart 400 may be performed, in one embodiment, by a wireless device 102. Flow chart 400 begins with element 402, receiving a broadcast message. This element may, in one embodiment, be performed by the listener module 104 of the wireless device 102 receiving the broadcast message via wireless network 110. The method of flow chart 400 continues to element 404, locating the profile information. The profile cache 106 may be queried to locate and/or determine the contents of the recipient's profile information. In decision block 406, the recipient's profile information may then be compared (such as by profile comparison module 108) to the broadcast message received in element 402 to determine if there is a match. If the recipient profile is not matched, the method continues back to element 402 where it awaits receipt of another broadcast message. If the recipient profile is matched, method 400 continues to element 408. Any type of methodology may be used to determine if the recipient profile matches the broadcast message. In one embodiment, a match may be made if any element of the recipient profile is found anywhere in the broadcast message. In other embodiments, a match may be made if any portion of the recipient profile is found in a particular location within the broadcast message, such as a specified field or header. In an alternative embodiment, multiple elements of the recipient profile must be found in the broadcast message for there to be a match. For example, a recipient may specify that a match will occur only when both their name and corporate affiliation are found in the broadcast message. This may be particularly useful when somebody has a common name and does not wish to receive broadcast messages not intended for them.

In element 408, the content of the broadcast message may be displayed to the recipient. The content may be displayed using, for example, a display 204 of the wireless device 102. A software program such as an XML browser may be suitable for use in displaying the content of a broadcast message. In one embodiment, the displayed broadcast message includes only text, but in other embodiments, the displayed broadcast message may include graphics or other objects.

Method 400 continues to optional decision block 410, where the wireless messaging computer 114 determines whether a recipient response is expected. If a recipient response is not expected by the wireless messaging computer 114, method 400 simply terminates. If a recipient response is expected by the wireless messaging computer 114, method 400 continues to optional element 412, receiving input from the recipient. A recipient may input a response via, for example, a user interface 208. Recipient input may include selecting an acknowledgement of receiving the message, a response to the message, an indication that the recipient has read the message, etcetera. The method of flow chart 400 then continues to element 414, transmitting a response message, after which the method terminates. In element 414, an indication of the recipient response may be transmitted to the wireless messaging computer 114 via wireless network 110. In an alternative embodiment, element 412 is not needed and element 414 automatically transmits a response (i.e., an acknowledgement) to the wireless messaging computer 114.

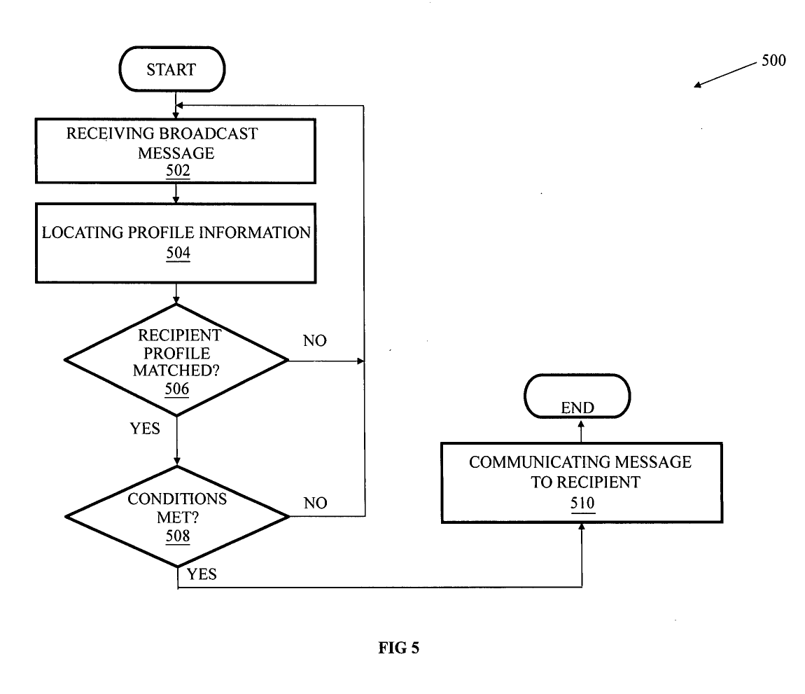

FIG. 5 depicts an example of a flow chart for receiving a broadcast message according to an alternative embodiment. The method of flow chart 500 may be performed, in one embodiment, by a wireless device 102. Flow chart 500 begins with element 502, receiving a broadcast message. This element may, in one embodiment, be performed by the listener module 104 of the wireless device 102 where the broadcast message may be received via wireless network 110.

The method of flow chart 500 continues to element 504, locating the profile information. In one embodiment, the profile cache 106 may be queried to locate and/or determine the contents of the recipient's profile information. In decision block 406, the recipient's profile information may then be compared (such as by profile comparison module 108) to the broadcast message received in element 402 to determine if there is a match. In decision block 506, the recipient's profile (as determined by element 504) may be compared to the broadcast message received in element 502 to determine if there is a match, as described in more detail in relation to element 406 in FIG. 4. If the recipient profile information is not matched, the method continues back to element 502 where it awaits receipt of another broadcast message. If the recipient profile information is matched, the method of flow chart 500 continues to decision block 508. In decision block 508, the method determines if any conditions imposed by the wireless messaging computer 114 are met. Conditions may include elements that must be in the recipient profile or elements that must not be in the recipient profile, or a combination thereof. In the depicted embodiment, as decision block 508 (for the conditions) is after decision block 506 (recipient profile match), the condition decision block 508 has the effect of overriding an affirmative response to decision block 508. In other words, even if a recipient has a recipient profile matching an element of the broadcast message any conditions imposed by the wireless messaging computer 114 must be satisfied in the depicted embodiment. If the conditions are satisfied in decision block 508, the method of flowchart 500 continues to element 510; otherwise, the method of flowchart 500 returns to element 502 where it awaits the receipt of another broadcast message. Next, in element 510, the content of the broadcast message may be displayed to the recipient after which flowchart 500 terminates.

In an alternative embodiment, decision block 508 may be performed before decision block 506 so that conditions are checked before the recipient profile. This embodiment may be useful when the wireless messaging computer 114 wishes to override the recipient profile determinations by, for example, forcing all wireless devices 102 to receive a particular broadcast message (such as a security or safety message).

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for providing a wireless message to a recipient on a wireless device. It is understood that the form of the invention shown and described in the detailed description and the drawings are to be taken merely as examples. It is intended that the following claims be interpreted broadly to embrace all the variations of the example embodiments disclosed.

What is claimed is:

1. A method for providing wireless electronic messaging to a wireless device on a wireless network, the method comprising:
receiving by the wireless device a broadcast message, having recipient information, from a wireless messaging computer;
comparing by the wireless device the recipient information to profile information; and
in response to a match of at least a portion of the recipient information to at least a portion of the profile information, communicating by the wireless device to a recipient at least a portion of the broadcast message.

2. The method of claim 1, further comprising:
receiving input on the wireless device in response to the displayed broadcast message; and
transmitting by the wireless device an indication of the input to the wireless messaging computer.

3. The method of claim 1, further comprising:
wherein the broadcast message further comprises one or more conditions for recipients of the broadcast message; and
determining by the wireless device if the profile information satisfies the conditions of the broadcast message.

4. The method of claim 1, further comprising locating by the wireless device the profile information stored within the wireless device.

5. The method of claim 1, wherein the profile information and recipient information each comprise at least one of a recipient name, a flight number, an organization, or an identifying number associated with the wireless device.

6. The method of claim 1, wherein the match occurs if at least one element in the profile information matches at least one element in the recipient information.

7. The method of claim 1, wherein the match occurs if at least two elements in the profile information match at least two elements in the recipient information.

8. The method of claim 1, wherein communicating by the wireless device at least a portion of the broadcast message comprises displaying by the wireless device at least a portion of the broadcast message.

9. The method of claim 1, wherein communicating by the wireless device at least a portion of the broadcast message comprises playing by the wireless device at least a portion of the broadcast message.

10. A method for providing wireless electronic messaging to at least one wireless device on a wireless network having a plurality of wireless devices capable of communicating on the network, the method comprising:
receiving by a wireless messaging computer a request to contact one or more of the wireless devices, the request comprising recipient information associated with the one or more wireless devices and message content;
generating by the wireless messaging computer a broadcast message incorporating at least a portion of the recipient information and the message content; and
broadcasting by the wireless messaging computer the broadcast message over the wireless network such that a plurality of the wireless devices in the wireless network receive the broadcast message, but only the wireless devices identified in the request communicate the message content to a recipient.

11. The method of claim 10, further comprising receiving by the wireless messaging computer a response to the broadcast message from a wireless device identified in the request via the wireless network.

12. The method of claim 10, further comprising specifying a condition by the wireless messaging computer for intended recipients of the broadcast message in the broadcast message.

13. The method of claim 10, wherein the recipient information comprises at least one of a recipient name, a flight number, an organization, or an identifying number associated with the wireless device.

14. A wireless device, comprising:
a listener module, the listener module being adapted to receive a broadcast message;
a profile cache, the profile cache being adapted to store a recipient profile;
a profile comparison module, the profile comparison module being adapted to determine if there is a match between the recipient profile and the broadcast message; and
a user communication module, the user communication module being adapted to communicate the broadcast message to a recipient in the event that at least a portion of the recipient profile matches at least a portion of the broadcast message.

15. The system of claim 14, further comprising a user interface.

16. The system of claim 14, wherein the wireless device comprises at least one of a wireless phone, a wireless pager, or a wireless personal digital assistant.

17. The system of claim 14, wherein the listener module is further adapted to transmit a response to the broadcast message.

18. The system of claim 14, wherein the recipient profile comprises at least one of a recipient name, a flight number, an organization, or an identifying number associated with the wireless device.

19. The system of claim 14, wherein the profile comparison module determines that a match is made if at least two portions of the recipient profile match at least two portions of the broadcast message.

20. The system of claim 14, wherein the user communication module comprises one or more of a display, a speaker, or a printer.
